(19) United States
(12) Patent Application Publication
(10) Pub. No.: US 2002/0041345 A1
(43) Pub. Date: Apr. 11, 2002

(54) Novel liquid crystal composition, reversible thermal recording medium using the same, and recording method for the recording medium

(75) Inventor: Mitsutoshi Nakamura, Kawanishi-Shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd.

(21) Appl. No.: 09/964,139

(22) Filed: Sep. 25, 2001

(30) Foreign Application Priority Data
Sep. 29, 2000 (JP) 2000-299450

(51) Int. Cl. G02F 1/13; C09K 19/00

(52) U.S. Cl. 349/1; 428/1.1

(57) ABSTRACT

Disclosed are a liquid crystal composition that is phase-changeable to a cholesteric liquid crystal phase when subjected to rapid heating or to a non-cholesteric liquid crystal phase when subjected to continuous heating, and a reversible thermal recording medium including a recording layer 3 containing the liquid crystal composition provided on a substrate 2. The recording medium assumes a state that causes selective reflection of light having a desired wavelength when subjected to rapid heating and subsequent rapid cooling, or a transparent state or a scattering white-colored state when subjected to continuous heating, whereby information is recorded.

### CROSS-REFERENCE TO RELATED APPLICATION

This application is based on Japanese Patent Application No. 2000-299450 filed in Japan on Sep. 29, 2000, the entire content of which is hereby incorporated by reference.

### BACKGROUND OF THE INVENTION

1. Field of the Invention

The present invention relates to a novel liquid crystal composition exhibiting a cholesteric phase, a reversible thermal recording medium using the same, and a recording method for the medium.

2. Description of the Related Art

In recent years, attention is directed to recording media enabling rewriting of information as a substitute for paper from the viewpoints of energy saving and environmental protection. Such rewritable recording media presently in practical use, however, are merely capable of black-and-white display or monochromatic display and, hence, recording media capable of full color display are desired.

A high-molecular cholesteric liquid crystal is known as a recording material that is rewritable and capable of full color display, but has not been put to practical use because of its low response speed in recording. A low/medium-molecular cholesteric liquid crystal as an improvement of the high-molecular cholesteric liquid crystal has been proposed as a recording material. This material enables full color display by being heated to an isotropic phase once, then cooled to a cholesteric phase exhibiting desired selective reflection, and further rapidly cooled from that temperature. A recording medium using this material involves problems that a large amount of energy is required to cause the liquid crystal to phase-change to the isotropic phase and that the temperature control is complicated. Further, in order to cause the liquid crystal to phase-change to a non-cholesteric phase, it is necessary for the recording medium to be heated to the isotropic phase or slowly cooled from a temperature once raised. Accordingly, the recording medium further involves a problem that it requires a large amount of energy and a long slow cooling period.

### SUMMARY OF THE INVENTION

Accordingly, it is an object of the present invention to provide liquid crystal composition, reversible thermal recording medium and recording method, which enable writing of information in a shorter time with a smaller amount of energy while allowing easy temperature control.

To attain the foregoing object, a first liquid crystal composition according to the present invention comprises:

a cholesteric liquid crystalline compound represented by the general formula (A):

[chemical structure]

where p1 and p2 are each an integer of 5 to 12, and

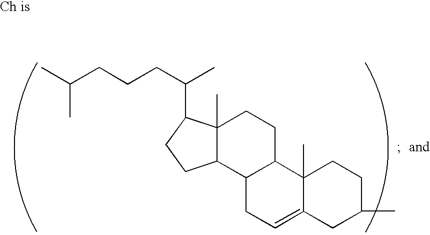

a cholesteric liquid crystalline compound represented by the general formula (B):

[chemical structure]

where r1 and r2 are each an integer of 3 to 10, and

[chemical structure]

A second liquid crystal composition according to the present invention comprises:

a cholesteric liquid crystalline compound represented by the general formula (C):

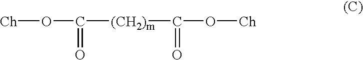

where m is an integer of 6 to 20, and

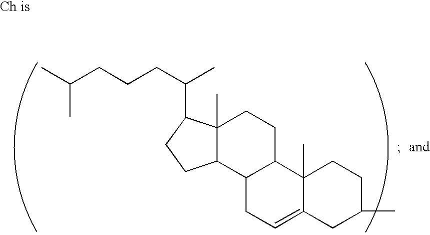

a cholesteric liquid crystalline compound represented by the general formula (D):

[chemical structure]

where q1, q2 and q3 are each an integer of 3 to 10, and

[chemical structure]

A third liquid crystal composition according to the present invention comprises the cholesteric liquid crystalline compounds represented by the foregoing general formulae (B) and (C), respectively.

A fourth liquid crystal composition according to the present invention comprises:

the cholesteric liquid crystalline compound represented by the foregoing general formula (C); and

a cholesteric liquid crystalline compound represented by the general formula (E):

[chemical structure]

where s1 and s2 are each an integer of 3 to 10, and

[chemical structure]

When the first to fourth liquid crystal compositions are each rapidly heated to a certain temperature, each composition is phase-changed to a cholesteric liquid crystal phase, and when each composition thus heated is rapidly cooled from that temperature, it becomes a selective reflection state corresponding to the temperature, whereby full color display is possible. Further, continuous heating causes these liquid crystal compositions to phase-change to a non-cholesteric liquid crystal phase in which they are in a transparent state or a scattering white-colored state. In this phase, information can be displayed or reset. Thus, the liquid crystal compositions are rewritable.

As used herein, “rapid heating” means heating to a predetermined temperature in a relatively short time, while “continuous heating” means a heating process including rapid heating to a predetermined temperature and keeping the temperature for a predetermined time period or including slow heating to keep a temperature equal to or higher than a predetermined temperature.

In making each of the first to fourth liquid crystal compositions assume a desired selective reflection state, there is no need to heat the composition once until it assumes an isotropic phase and then cool it to a predetermined temperature and, hence, each composition requires a smaller amount of energy, a shorter writing time, and easier temperature control.

A reversible thermal recording medium according to the present invention comprises a recording layer containing a liquid crystal composition that is phase-changeable to a cholesteric liquid crystal phase when subjected to rapid heating or to a non-cholesteric liquid crystal phase when subjected to continuous heating. Various compositions may be used in the recording medium so long as they are phase-changeable to a cholesteric liquid crystal phase when subjected to rapid heating or to a non-cholesteric liquid crystal phase when subjected to continuous heating. Particularly, the liquid crystal composition preferably contains the cholesteric liquid crystalline compounds represented by the foregoing general formulae (A) and (B), the cholesteric liquid crystalline compounds represented by the foregoing general formulae (C) and (D), the cholesteric liquid crystalline compounds represented by the foregoing general formulae (B) and (C), or the cholesteric liquid crystalline compounds represented by the foregoing general formulae (C) and (E).

In the recording medium having a recording layer containing such cholesteric liquid crystalline compounds, the liquid crystalline compounds are phase-changed to a cholesteric liquid crystal phase by rapid heating thereby enabling display in a desired color, and the display state is fixed by subsequent rapid cooling. Further, the liquid crystal compounds are phase-changed to a non-cholesteric liquid crystal phase by continuous heating to assume a predetermined display state or a reset state.

A recording method according to the present invention comprises subjecting a reversible thermal recording medium comprising a recording layer containing a cholesteric liquid crystal composition to rapid heating and subsequent rapid cooling or to continuous heating selectively, to record desired information on the recording medium.

In this recording method, it is preferred that the temperature increase rate of the rapid heating be 100° C./min or higher and the cooling rate of the rapid cooling be 100° C./min or higher. The “continuous heating” is a heating process including rapid heating to a predetermined temperature and keeping the temperature for a predetermined time period, or including slow heating to keep a temperature equal to or higher than a predetermined temperature. The temperature increase rate of the slow heating is preferably 10° C./min or lower.

### BRIEF DESCRIPTION OF THE DRAWINGS

These and other objects, advantages and features of the invention will become apparent from the following description thereof taken in conjunction with the accompanying drawings in which:

FIG. 1 is a sectional view illustrating one embodiment of a reversible thermal recording medium according to the present invention.

### PREFERRED EMBODIMENTS OF THE INVENTION

Hereinafter, embodiments of novel liquid crystal composition, reversible thermal recording medium and recording method according to the present invention will be described.

Novel Liquid Crystalline Compounds

A novel liquid crystal composition according to the present invention is phase-changeable to a cholesteric liquid crystal phase when subjected to rapid heating or to a non-cholesteric liquid crystal phase when subjected to continuous heating. This composition contains at least one of the compounds represented by the following general formulae (A) to (E). These compounds may be used either alone or as a mixture of two or more of them in a recording material. In the case of such a mixture of two or more of the compounds, whether or not the resulting composition exhibits a cholesteric liquid crystal phase when subjected to rapid heating depends upon the kinds of compounds mixed and the mixing ratio. Even if the composition exhibits the cholesteric liquid crystal phase, the time period in which the composition is phase-changed to a non-cholesteric liquid crystal phase by continuous heating largely varies depending upon the kinds of compounds mixed and the mixing ratio. It is therefore necessary to select the kinds of compounds to be used and determine the mixing ratio thereof taking applications of the composition as a recording medium and the like into consideration. General formulae (A) to (E):

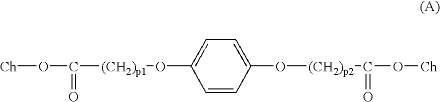

where p1 and p2 are each an integer of 5 to 12;

[chemical structure]

where r1 and r2 are each an integer of 3 to 10;

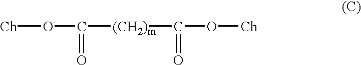

where m is an integer of 6 to 20;

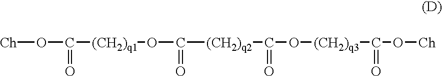

where q1, q2 and q3 are each an integer of 3 to 10; and

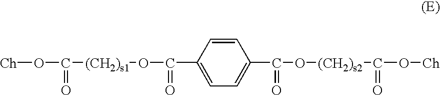

where s1 and s2 are each an integer of 3 to 10.

In the formulae (A) to (E), Ch is

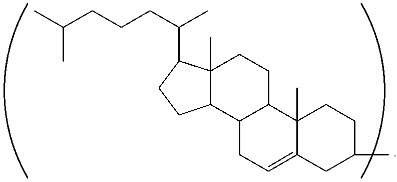

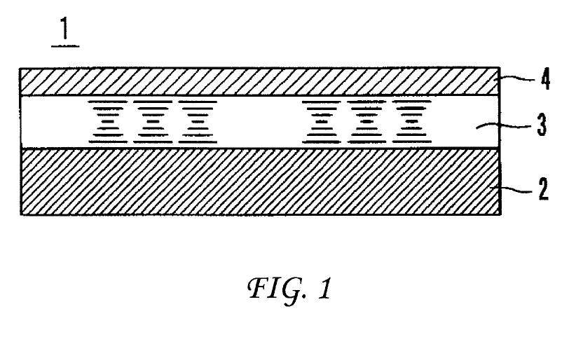

Reversible Thermal Recording Medium (See FIG. 1)

One embodiment of a reversible thermal recording medium according to the present invention is described below with reference to FIG. 1. The construction of the reversible thermal recording medium according to the present invention may be varied variously without limitation to the embodiment illustrated below.

Reversible thermal recording medium 1 shown in FIG. 1 includes a recording layer comprising a cholesteric liquid crystal composition provided on a substrate 2, and an optional protective layer 4 stacked on the recording layer 3 as required.

The substrate 2 may be formed of a material selected from a wide variety of materials such as glass, plastic, metal, paper and the like as long as it can maintain the mechanical strength of the recording medium 1 and has a thermal deformation temperature equal to or higher than the melting point of the material forming the recording layer 3. If the substrate is provided with a light-absorbing layer on the obverse or reverse side thereof, the recording layer 3 in a transparent state can be displayed in black because the light-absorbing layer absorbs transparent light. A similar effect will result when a light-absorbing agent is included in the substrate 2.

The recording layer 3 contains a liquid crystal composition that is phase-changeable to a cholesteric liquid crystal phase when subjected to rapid heating or to a non-cholesteric liquid crystal phase when subjected to continuous heating. The compounds represented by the foregoing general formulae (A) to (E) are preferably used for such liquid crystal compositions. These compounds may be used as dispersed in a suitable transparent resin binder such as polycarbonate, PMMA, polyvinyl alcohol or polyamide.

The protective layer 4 serves to protect the surface of the recording layer 3 physically and chemically and is optionally provided as required. A material having superior light transmissivity and high heat resistance, such as a plastic sheet or film, or glass, is preferably used for the protective layer 4.

The recording layer 3 may incorporate spacers or resin structural members to keep its thickness constant. Further, an alignment control film may be formed on the side of the substrate 2 or protective layer 4 contacting the recording layer 3.

When the reversible thermal recording medium 1 thus constructed is heated rapidly from room temperature, a color resulting from selective reflection corresponding to the temperature of the medium 1 heated is observed within the temperature range in which the liquid crystal exhibits a cholesteric liquid crystal phase. The selectively reflected wavelength continuously varies with varying temperature and, accordingly, the color resulting from selective reflection varies continuously. By rapidly cooling the medium 1 from that temperature, the selective reflection state is fixed with the result that information is displayed. By controlling the temperature to which the medium 1 is rapidly heated, display in a desired color is possible, and full color display is also possible.

According to the experiments conducted by the inventors of the present invention, the temperature increase rate of the rapid heating and the cooling rate of the rapid cooling were each 100° C./min or higher. When the recording layer 3 is continuously heated from room temperature, the liquid crystal is phase-changed to a non-cholesteric liquid crystal phase and assumes a transparent state or a scattering white-colored state. In the transparent state, the recording layer 3 is displayed in black if the light-absorbing layer is provided on the reverse side of the recording layer 3. Display in white is also possible. Alternatively, by utilizing the transparent state or the scattering wbite-colored state to reset the display, the recording medium 1 is rendered rewritable.

The “continuous heating”, as used herein, is a heating process including rapid heating to a predetermined temperature and keeping the temperature for a predetermined time period (for example, one second or longer), or including slow heating to keep a temperature equal to or higher than a predetermined temperature. According to the experiments conducted by the inventors of the present invention, the temperature increase rate of the slow heating was 10° C./min or lower.

Means to achieve such different heating states are, for example, a hot plate, a thermal head, a hot stamp, a cold stamp, and the like. Use of a laser beam scanning head is also possible. Of course, any other means that can achieve the predetermined temperature conditions can be used.

Specific Examples of Recording Media and Recording Methods

Specific examples of reversible thermal recording media prepared by the inventors of the present invention are described below as Examples 1 to 6. As well, methods of recording information on these examples and results of recording are described. For comparison, Comparative Examples 1 and 2 are also described.

### EXAMPLE 1

A black polyethylene terephthalate film having a thickness of 100 μm was used as a substrate, and a mixture of compounds represented by the following chemical formulae (A1) and (B1) mixed at a weight ratio of 1:2 was applied to the substrate to a thickness of 10 μm to form a recording layer. Further, a transparent polyethylene terephthalate film having a thickness of 6 μm was superposed on the recording layer, to give a recording medium.

[chemical structure]

In each of the formulae (A1) and (B1), Ch is

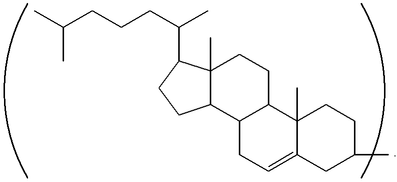

The entire recording layer of the recording medium thus prepared was rapidly heated to 100° C. and then rapidly cooled. As a result, the recording layer was wholly color-changed to green, which was maintained after the rapid cooling. Subsequently, (1) the recording medium wholly green-colored was rapidly heated to 100° C. by means of a hot stamp engraved with characters and 10 seconds thereafter the hot stamp was detached from the recording medium. As a result, heated portions of the recording layer became transparent and, hence, the characters were displayed in black against the green background. Alternatively, (2) the recording medium wholly green-colored was heated to 100° C. at a temperature increase rate of 2° C./min by means of a hot stamp engraved with characters. As a result, heated portions of the recording layer became transparent and, hence, the characters were displayed in black against the green background. Still alternatively, (3) the recording medium wholly green-colored was rapidly heated to 130° C. by means of a hot stamp engraved with characters and then rapidly cooled. As a result, heated portions of the recording layer were color-changed to blue and, hence, the characters were displayed in blue against the green background. Further, portions of the recording layer other than the previously heated portions were rapidly heated to 130° C. by means of a hot stamp engraved with characters and 10 seconds thereafter the hot stamp was detached from the recording medium. As a result, the heated portions of the recording layer became transparent and, hence, the characters were displayed in black against the green background. Thus, a series of these operations enabled recording of characters in two different colors, namely blue and black, against the green background.

### EXAMPLE 2

A black glass plate having a thickness of 100 μM was used as a substrate, and a mixture of the compounds represented by the foregoing chemical formulae (A1) and (B1) mixed at a weight ratio of 1:2 was applied to the substrate to a thickness of 20 μm to form a recording layer. Thus, a recording medium was prepared.

The entire recording layer of the recording medium thus prepared was rapidly heated to 80° C. and then rapidly cooled. As a result, the recording layer was wholly color-changed to red, which was maintained after the rapid cooling. Subsequently, the recording medium wholly red-colored was rapidly heated to 100° C. by means of a hot stamp engraved with characters and 10 seconds thereafter the hot stamp was detached from the recording medium. As a result, heated portions of the recording layer assumed a scattering white-colored state and, hence, the characters were displayed in white against the red background.

### EXAMPLE 3

A black polyethylene terephthalate film having a thickness of 100 μm was used as a substrate, and a mixture of the compounds represented by the foregoing chemical formulae (A1) and (B1) mixed at a weight ratio of 1:1 was applied to the substrate to a thickness of 10 μm to form a recording layer. Further, a transparent polyethylene terephthalate film having a thickness of 6 μm was superposed on the recording layer, to give a recording medium.

The entire recording layer of the recording medium thus prepared was rapidly heated to 100° C. and then rapidly cooled. As a result, the recording layer was wholly color-changed to green, which was maintained after the rapid cooling. Subsequently, the recording medium wholly green-colored was rapidly heated to 80° C. by means of a hot stamp engraved with characters and then rapidly cooled. As a result, heated portions of the recording layer were color-changed to red and, hence, the characters were displayed in red against the green background. Further, portions of the recording layer other than the previously heated portions were rapidly heated to 80° C. by means of a hot stamp engraved with characters and two minutes thereafter the hot stamp was detached from the recording medium. As a result, the portions having just been heated of the recording layer were color-changed to light red and, hence, the characters were displayed in light red against the green background. Still further, portions of the recording layer other than the previously heated portions were rapidly heated to 80° C. by means of a hot stamp engraved with characters and five minutes thereafter the hot stamp was detached from the recording medium. As a result, the portions having just been heated of the recording layer became transparent and, hence, the characters were displayed in black against the green background. Thus, a series of these operations enabled recording of characters in three different colors, namely red, light red and black, against the green background.

### EXAMPLE 4

A black polyethylene terephthalate film having a thickness of 100 μm was used as a substrate, and a mixture of compounds represented by the following chemical formulae (C1) and (D1) mixed at a weight ratio of 1:1 was applied to the substrate to a thickness of 10 μm to form a recording layer. Further, a transparent polyethylene terephthalate film having a thickness of 6 μm was superposed on the recording layer, to give a recording medium.

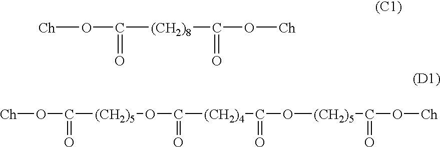

In each of the formulae (C1) and (D1), Ch is

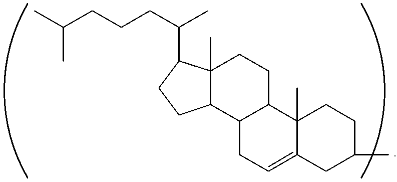

The entire recording layer of the recording medium thus prepared was rapidly heated to 100° C. and then rapidly cooled. As a result, the recording layer was wholly color-changed to green, which was maintained after the rapid cooling. Subsequently, the recording medium wholly green-colored was rapidly heated to 100° C. by means of a hot stamp engraved with characters and two minutes thereafter the hot stamp was detached from the recording medium. As a result, heated portions of the recording layer became transparent and, hence, the characters were displayed in black against the green background.

### EXAMPLE 5

A black polyethylene terephthalate film having a thickness of 100 μm was used as a substrate, and a mixture of the compounds represented by the foregoing chemical formulae (B1) and (C1l) mixed at a weight ratio of 1:1 was applied to the substrate to a thickness of 10 μm to form a recording layer. Further, a transparent polyethylene terephthalate film having a thickness of 6 μm was superposed on the recording layer, to give a recording medium.

The entire recording layer of the recording medium thus prepared was rapidly heated to 80° C. and then rapidly cooled. As a result, the recording layer was wholly color-changed to green, which was maintained after the rapid cooling. Subsequently, the recording medium wholly green-colored was rapidly heated to 80° C. by means of a hot stamp engraved with characters and five seconds thereafter the hot stamp was detached from the recording medium. As a result, heated portions of the recording layer became transparent and, hence, the characters were displayed in black against the green background.

### EXAMPLE 6

A black polyethylene terephthalate film having a thickness of 100 μm was used as a substrate, and a mixture of the compound represented by the foregoing chemical formula (C1) and a compound represented by the following chemical formula (E1) mixed at a weight ratio of 1:1 was applied to the substrate to a thickness of 10 μm to form a recording layer. Further, a transparent polyethylene terephthalate film having a thickness of 6 μm was superposed on the recording layer, to give a recording medium.

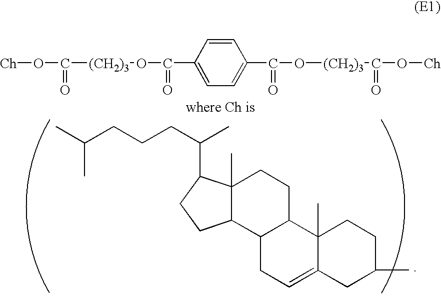

The entire recording layer of the recording medium thus prepared was rapidly heated to 100° C. and then rapidly cooled. As a result, the recording layer was wholly color-changed to green, which was maintained after the rapid cooling. Subsequently, the recording medium wholly green-colored was rapidly heated to 100° C. by means of a hot stamp engraved with characters and ten seconds thereafter the hot stamp was detached from the recording medium. As a result, heated portions of the recording layer became transparent and, hence, the characters were displayed in black against the green background.

### COMPARATIVE EXAMPLE 1

A black polyethylene terephthalate film having a thickness of 100 μm was used as a substrate, and a compound represented by the following chemical formula (F1) was applied to the substrate to a thickness of 10 μm to form a recording layer. Further, a transparent polyethylene terephthalate film having a thickness of 6 μm was superposed on the recording layer, to give a recording medium.

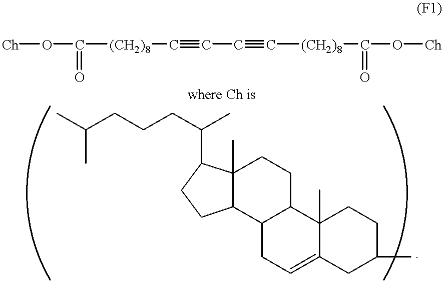

The entire recording layer of the recording medium thus prepared was heated to 130° C. once, cooled to 95° C., and then rapidly cooled further. As a result, the recording layer was wholly color-changed to green. Subsequent rapid heating from room temperature to 95° C., however, did not cause the recording layer to develop any color.

### COMPARATIVE EXAMPLE 2

A black polyethylene terephthalate film having a thickness of 100 μm was used as a substrate, and a mixture of the compound represented by the foregoing chemical formula (F1) and a compound represented by the following chemical formula (C2) mixed at a weight ratio of 1:1 was applied to the substrate to a thickness of 10 μm to form a recording layer. Further, a transparent polyethylene terephthalate film having a thickness of 6 μm was superposed on the recording layer, to give a recording medium.

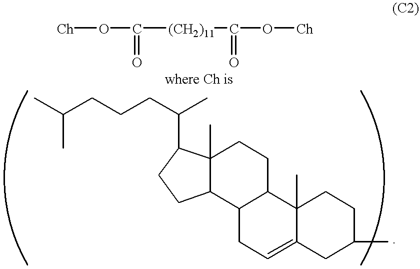

The entire recording layer of the recording medium thus prepared was rapidly heated to 90° C. and then rapidly cooled. As a result, the recording layer was wholly color-changed to green. Subsequent continuous heating, however, did not cause the recording layer to become transparent.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A liquid crystal composition comprising:
a cholesteric liquid crystalline compound represented by the general formula (A): 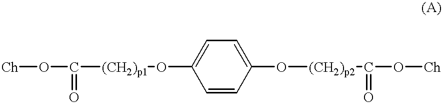
where p1 and p2 are each an integer of 5 to 12, and
Ch is 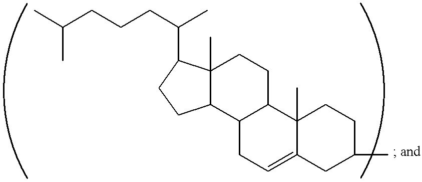
a cholesteric liquid crystalline compound represented by the general formula (B): 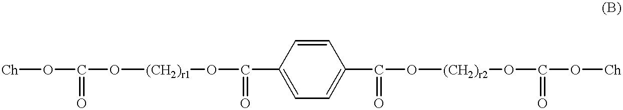
where r1 and r2 are each an integer of 3 to 10, and
Ch is

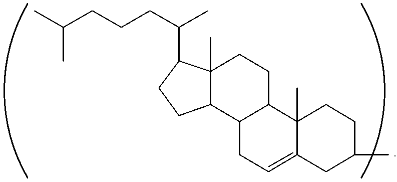

2. A liquid crystal composition comprising:
a cholesteric liquid crystalline compound represented by the general formula (C): 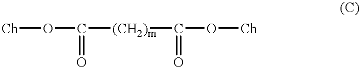
where m is an integer of 6 to 20, and
Ch is 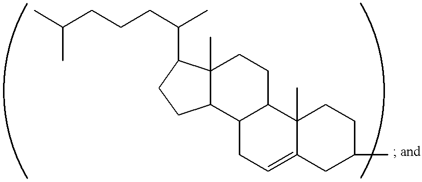
a cholesteric liquid crystalline compound represented by the general formula (D): 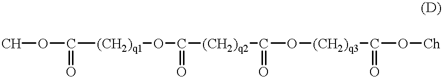
where q1, q2 and q3 are each an integer of 3 to 10, and
Ch is

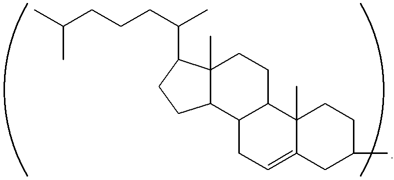

3. A liquid crystal composition comprising:
a cholesteric liquid crystalline compound represented by general formula (B): 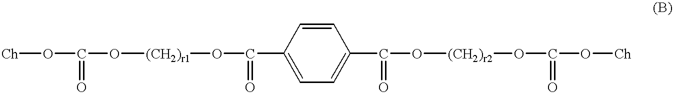
where r1 and r2 are each an integer of 3 to 10, and
Ch is 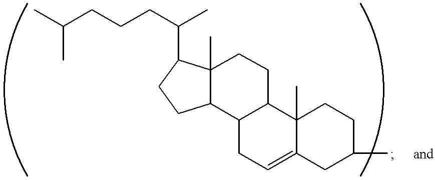
a cholesteric liquid crystalline compound represented by general formula (C); 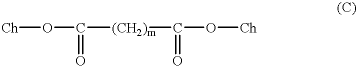
where m is an integer of 6 to 20, and
Ch is

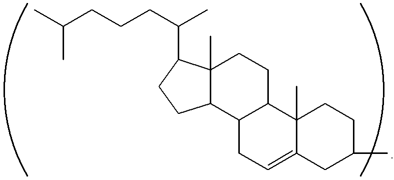

4. A liquid crystal composition comprising:
a cholesteric liquid crystalline compound represented by general formula (C); 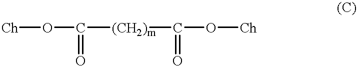
where m is an integer of 6 to 20, and
Ch is 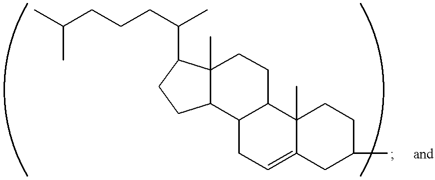
a cholesteric liquid crystalline compound represented by the general formula (E): 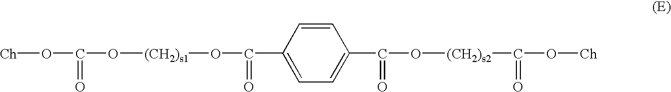
where s1 and s2 are each an integer of 3 to 10, and
Ch is

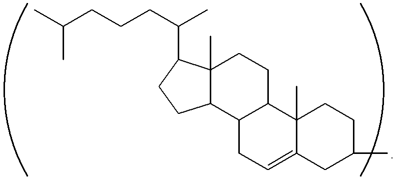

5. A reversible thermal recording medium comprising a recording layer containing a liquid crystal composition that is phase-changeable to a cholesteric liquid crystal phase when subjected to rapid heating or to a non-cholesteric liquid crystal phase when subjected to continuous heating.

6. A reversible thermal recording medium comprising a recording layer containing a liquid crystal composition as recited in claim 1.

7. A reversible thermal recording medium comprising a recording layer containing a liquid crystal composition as recited in claim 2.

8. A reversible thermal recording medium comprising a recording layer containing a liquid crystal composition as recited in claim 3.

9. A reversible thermal recording medium comprising a recording layer containing a liquid crystal composition as recited in claim 4.

10. A recording method comprising subjecting a reversible thermal recording medium as recited in claim 5 to rapid heating and subsequent rapid cooling or to continuous heating selectively, to record desired information on the recording medium.

11. The recording method according to claim 10, wherein the temperature increase rate of the rapid heating is 100° C./min or higher and the cooling rate of the rapid cooling is 100° C./min or higher.

12. The recording method according to claim 10, wherein the continuous heating is a heating process including rapid heating to a predetermined temperature and keeping the temperature for a predetermined time period, or including slow heating to keep a temperature equal to or higher than a predetermined temperature.

13. The recording method according to claim 12, wherein the temperature increase rate of the slow heating is 10° C./min or lower.

14. A recording method comprising subjecting a reversible thermal recording medium as recited in claim 6 to rapid heating and subsequent rapid cooling or to continuous heating selectively, to record desired information on the recording medium.

15. The recording method according to claim 14, wherein the temperature increase rate of the rapid heating is 100° C./min or higher and the cooling rate of the rapid cooling is 100° C./min or higher.

16. The recording method according to claim 14, wherein the continuous heating is a heating process including rapid heating to a predetermined temperature and keeping the temperature for a predetermined time period, or including slow heating to keep a temperature equal to or higher than a predetermined temperature.

17. The recording method according to claim 16, wherein the temperature increase rate of the slow heating is 10° C./min or lower.

18. A recording method comprising subjecting a reversible thermal recording medium as recited in claim 7 to rapid heating and subsequent rapid cooling or to continuous heating selectively, to record desired information on the recording medium.

19. The recording method according to claim 18, wherein the temperature increase rate of the rapid heating is 100° C./min or higher and the cooling rate of the rapid cooling is 100° C./min or higher.

20. The recording method according to claim 18, wherein the continuous heating is a heating process including rapid heating to a predetermined temperature and keeping the temperature for a predetermined time period, or including slow heating to keep a temperature equal to or higher than a predetermined temperature.

21. The recording method according to claim 20, wherein the temperature increase rate of the slow heating is 10° C./min or lower.

22. A recording method comprising subjecting a reversible thermal recording medium as recited in claim 8 to rapid heating and subsequent rapid cooling or to continuous heating selectively, to record desired information on the recording medium.

23. The recording method according to claim 22, wherein the temperature increase rate of the rapid heating is 100° C./min or higher and the cooling rate of the rapid cooling is 100° C./min or higher.

24. The recording method according to claim 22, wherein the continuous heating is a heating process including rapid heating to a predetermined temperature and keeping the temperature for a predetermined time period, or including slow heating to keep a temperature equal to or higher than a predetermined temperature.

25. The recording method according to claim 24, wherein the temperature increase rate of the slow heating is 10° C./min or lower.

26. A recording method comprising subjecting a reversible thermal recording medium as recited in claim 9 to rapid heating and subsequent rapid cooling or to continuous heating selectively, to record desired information on the recording medium.

27. The recording method according to claim 26, wherein the temperature increase rate of the rapid heating is 100° C./min or higher and the cooling rate of the rapid cooling is 100° C./min or higher.

28. The recording method according to claim 26, wherein the continuous heating is a heating process including rapid heating to a predetermined temperature and keeping the temperature for a predetermined time period, or including slow heating to keep a temperature equal to or higher than a predetermined temperature.

29. The recording method according to claim 28, wherein the temperature increase rate of the slow heating is 10° C./min or lower.
